(19) United States
(12) Patent Application Publication
(10) Pub. No.: US 2015/0347958 A1
(43) Pub. Date: Dec. 3, 2015

(54) APPARATUS AND METHOD OF PROVIDING SUPPLY INFORMATION IN REAL TIME

(71) Applicant: SAMSUNG SDS CO., LTD., Seoul (KR)

(72) Inventors: Kang Hyoung CHO, Seoul (KR); Jae Kyu HAN, Yongin-si (KR); Sung Youn KIM, Seongnam-si (KR)

(73) Assignee: SAMSUNG SDS CO., LTD., Seoul (KR)

(21) Appl. No.: 14/582,909

(22) Filed: Dec. 24, 2014

(30) Foreign Application Priority Data
May 27, 2014 (KR) 10-2014-0063675

(51) Int. Cl. G06Q 10/08; G06Q 10/06

(52) U.S. Cl. CPC G06Q 10/087; G06Q 10/06312

(57) ABSTRACT

Providing supply information in real-time including: providing, in real-time information about a change in a supply state generated before products are stored, and changing supply information including information about available-to-promise products; and adjusting, in real-time, a delivery deadline of delivery promised supply quantities based on the changed supply information in response to the supply information being changed.

### CROSS-REFERENCE TO RELATED APPLICATION

This application claims priority from Korean Patent Application No. 10-2014-0063675 filed on May 27, 2014 in the Korean Intellectual Property Office, and all the benefits accruing therefrom under 35 U.S.C. 119, the disclosure of which in its entirety is incorporated herein by reference.

### BACKGROUND

1. Field

A method and an apparatus consistent with exemplary embodiments broadly relate to providing supply information in real time, and a computer readable recording medium and a system using the same.

2. Description of the Related Art

A technique for managing a production and distribution process of products through one combined chain includes a so-called supply chain management (SCM) technique. The SCM technique is a technique for enabling a user to recognize at a glance and manage an entire process in which information about products is moved from a producer to a wholesaler, a retail vendor, and a customer. Through the SCM, a manufacturing company and the like may supply products desired by customers at a proper time, and decrease inventory. A seller may also sell in-transit products, products stocked in a storage of a factory, products subjected to be produced, and the like, in some cases, even though products do not exist in an inventory storage. In the SCM technique, there is no technique for changing and managing supply information in real time when in-transit products arrive at a storage, a warehouse facility, and the like so that warehousing information is generated, and changing information on delivery promised quantities.

### SUMMARY

Aspects of exemplary embodiments relate to a method and an apparatus for providing supply information in real time, which provides information on a supply state generated by a situation different from an arranged schedule, such as when products are transported at a time earlier than then the scheduled time, and to supply such information in real time, and change the supply information.

An aspect of exemplary embodiments relate to a method and an apparatus for providing supply information in real time, where the supply information indicates warehouse or storage information in real time, and to adjusting a delivery deadline of delivery promised quantities by using the changed supply information.

An aspect of exemplary embodiments further relate to a method and an apparatus for providing supply information in real time, which are capable of reorganizing a delivery deadline of delivery promised quantities in real time whenever a supply state is changed.

Aspects of exemplary embodiments are not limited to the aforementioned technical aspects and other technical aspects which are not mentioned will be readily apparent to those skilled in the art from the following description of exemplary embodiments.

According to an aspect of an exemplary embodiment, a method of providing supply information, includes: providing, in real-time, information about a change in a supply state of products generated before products are stored, and changing supply information comprising information about available-to-promise quantities based on the provided information; and adjusting, in real-time, a delivery deadline of delivery promised quantities based on the changed supply information in response to said changing of the supply information.

According to yet another aspect of an exemplary embodiment, a non-transitory computer readable recording medium stores a computer program for performing a method of providing supply information.

According to yet another aspect of an exemplary embodiment, an apparatus for providing, in real-time supply information includes: a supply information change component configured to provide, in real-time, information about a supply state of products generated before the products are stored, and to change supply information including information about available-to-promise quantities based on the provided information; and a delivery deadline adjustment component configured to adjust, in real-time, a delivery deadline of delivery promised quantities based on the changed supply information in response to the change in the supply information.

According to yet another exemplary embodiment, a system of providing supply information includes: a first server configured to provide, in real-time, information about a supply state of products generated before products are stored, and to change supply information including information about available-to-promise quantities based on the provided information; and a second server configured to adjust, in real-time, a delivery deadline of delivery promised quantities based on the changed supply information in response to the supply information being changed.

According to yet another aspect of an exemplary embodiment, the system may further include a supply state information collecting device configured to collect information about the supply state.

According to yet another aspect of an exemplary embodiment, in response to a change in a supply state being different from a schedule change, it is possible to provide, in real-time, information about the supply state to a supply plan.

According to yet another aspect of an exemplary embodiment, it is possible to adjust, in real-time, a delivery deadline of delivery promised quantities based on changed supply information, and further, when information about a supply state is generated, it is possible to adjust, in real-time, a delivery deadline of delivery promised quantities. According to exemplary embodiments, it is possible to reduce costs associated with storing products in a storage or a warehouse by adjusting, in real-time or on the fly, a delivery deadline of delivery promised quantities. Further, according to exemplary embodiments, it is possible to decrease time when products are stored in a storage or a warehouse, and it is possible to efficiently utilize storage space.

According to exemplary embodiments, it is possible to more quickly deliver products to a customer compared to the related art by adjusting, in real-time, a delivery deadline of delivery promised quantities.

Aspects of exemplary embodiments are not limited to the aspects described above, and other aspects that are not described will be clearly understood by a person skilled in the art from the description of exemplary embodiments below.

### BRIEF DESCRIPTION OF THE DRAWINGS

The above and/or other aspects will become more apparent by describing in detail certain exemplary embodiments with reference to the accompanying drawings, in which:

FIG. 1 is a block diagram illustrating an apparatus, which provides supply information in real time according to an exemplary embodiment;

FIG. 2 is a block diagram illustrating a hardware configuration of an apparatus, which provides supply quantity information in real time according to another exemplary embodiment;

FIG. 3 is a block diagram illustrating a system which provides supply information in real time according to an exemplary embodiment;

FIG. 4 is a flowchart illustrating a method of providing supply information in real time according to an exemplary embodiment;

FIG. 5 is a flow diagram illustrating a relationship between supply information and delivery promised quantities in a method of providing supply information in real time according to exemplary embodiment;

FIG. 6 is a chart illustrating an instance in which products arrive at a time earlier than a scheduled time according to an exemplary embodiment;

FIGS. 7 to 9 are charts illustrating a change of supply information and an adjustment of a delivery deadline of delivery promised quantities according to an exemplary embodiment;

FIG. 10 is a chart illustrating delivery promised quantities adjusted based on supply information changed by a delivery deadline adjustment component according to an exemplary embodiment;

FIG. 11 is a flow diagram illustrating a change in supply information according to an exemplary embodiment; and

FIG. 12 is a flow diagram illustrating an adjustment in a delivery deadline of delivery promised quantities by a delivery deadline adjustment component according to an exemplary embodiment.

### DETAILED DESCRIPTION OF EXEMPLARY EMBODIMENTS

Exemplary features and aspects of exemplary embodiment may be understood more readily by reference to the following detailed description of exemplary embodiments and the accompanying drawings. Exemplary embodiments may, however, be embodied in many different forms and should not be construed as being limited to the exemplary embodiments set forth herein. Rather, these exemplary embodiments are provided so that this disclosure will be thorough and complete and will fully convey an inventive concept to those skilled in the art, and the inventive concept will only be defined by the appended claims. Like reference numerals refer to like elements throughout the specification.

The terminology used herein is for the purpose of describing exemplary embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross-section illustrations that are schematic illustrations of exemplary embodiments. As such, variations from the shapes of the illustrations as a result, for example, of manufacturing techniques and/or tolerances, are to be expected. Thus, these exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of an inventive concept.

Unless otherwise defined, all terms (including technical and scientific terms) used herein have the same meaning as commonly understood by one of ordinary skill in the art to which exemplary embodiments belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

FIG. 1 is a block diagram illustrating an apparatus which provides supply information in real time according to an exemplary embodiment.

Referring to FIG. 1, an apparatus 100 for providing supply information in real time according to an exemplary embodiment may include a supply information change component 110 and a delivery deadline adjustment component 120.

The supply information change component 110 may provide information on a supply state generated until products are warehoused or stored in real time, and change supply information including information on available-to-promise quantities.

The information on the supply state generated until products are warehoused or stored may include information on all types of supply state generated from a production plan of products until the products are warehoused or stored.

Particularly, for example, the information on the supply state may include at least one element of information among information on a production plan state, information on a factory inventory state, information on an in-transit (IT) state, and information on their storage/warehouse state. However, this is merely an example of the supply state, and various supply states may exist in addition to the aforementioned states, and the information on the supply state may include information on various supply states.

The information on the supply state may include information on a changed supply state. The change of the supply state may mean that a supply state becomes a supply state different from a scheduled supply state. For example, products are scheduled to be in transit at a current time, but when the products are warehoused at an earlier time than a scheduled time, the supply state may be changed from an in-transit state to a warehouse/storage state.

An example of warehousing or storing products may include warehousing or storing of in-transit products at a storage place, such as a storage, but the warehousing or storing of products is not limited thereto, an arrival of in-transit products to a storage place may be considered as warehousing or storing of products.

The information about the supply state may include information about a changed supply state, and may also include information about a time at which the supply state is changed. Further, the information about the supply state may include information about supply quantities of which a supply state is changed. For example, the information on the warehousing/storing state among the supply states may include information on warehoused or stored quantities of in-transit products, which are warehoused in storage, and may also include information on a warehousing or storage time. The warehousing or storing information may include various information, such as information on a scheduled transport time, as well as the information on the warehoused stored quantities and the warehoused or time of storage.

The information about the supply state may be generated whenever the supply state is changed, and when products are warehoused, the information about the supply state may be generated in real time, or almost in real-time. The term “real time” used in the present specification may include an equivalent to almost real time.

The information on the supply state may be automatically generated by a specific device when the supply state is changed, and the information about the supply state may also be input by a specific device, by a person such as a person in charge. The specific device may be a device including a sensor and a processor which are capable of collecting and processing information about changed supply quantities and changed time.

The supply information change component 110 may change the supply information in real time by using the received information about the supply state. The supply information which changes in real time includes information on available-to-promise quantities.

The available-to-promise quantities mean allocable quantities at a specific delivery term. That is, the available-to-promise quantities mean available quantities for making a delivery appointment or of which a delivery appointment can be made. The information on the available-to-promise quantities may exist for each term or each time. The term may be various temporal terms, such as a week unit or a day unit. That is, the supply information may include information on a supply plan about products for keeping a delivery appointment for each term (for example, for each date). The supply information may include information on available-to-promise quantities for each term.

The delivery deadline adjustment component 120 may adjust a delivery deadline of delivery promised quantities.

The delivery promised quantities mean supply quantities, of which when an order is received from a customer and the like, a delivery deadline for delivering products based on the order, is promised. The delivery deadline adjustment component 120 may reorganize a delivery deadline of the delivery promised quantities in real time whenever the supply information is changed.

It is noted that in an exemplary embodiment, the supply information change component 110 and the delivery deadline adjustment component 120 can be executed as software components running on a hardware processor or as a combination of software and hardware, or as separate hardware circuits.

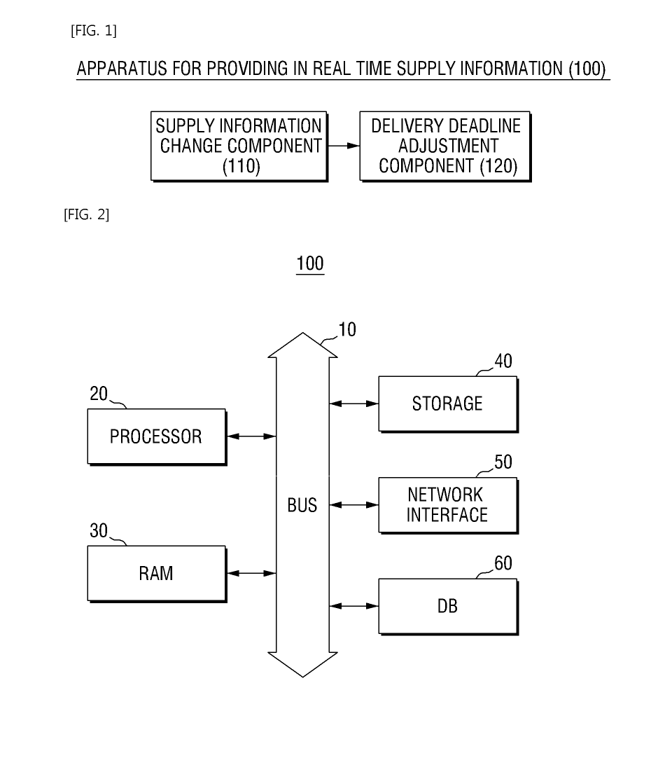

FIG. 2 is a block diagram illustrating a hardware configuration of an apparatus which provides supply information in real time according to an exemplary embodiment.

Referring to FIG. 2, the apparatus of providing supply information in real time according to an exemplary embodiment may include a system bus 10, a processor 20, a random access memory (RAM) 30, a storage 40, a network interface 50 for communicating with an external device, and a database (DB) 60. A computer program code implementing a method of reflecting supply information in real time according to an exemplary embodiment may be stored in the storage 40, loaded to the RAM 30, and executed by the processor 20.

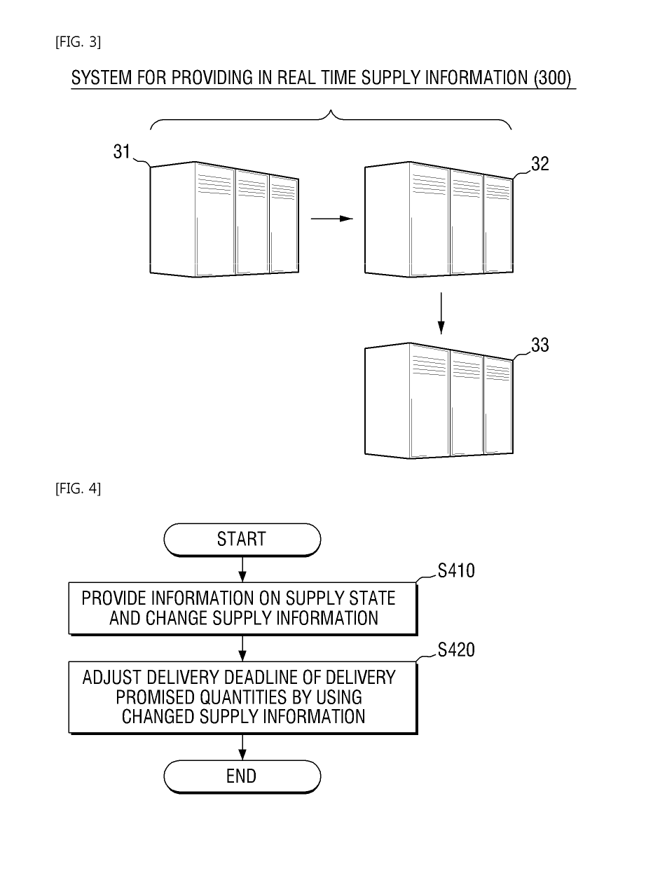

FIG. 3 is a block diagram illustrating a system which provides supply information in real time according to an exemplary embodiment.

Referring to FIG. 3, a system 300 which provides supply information in real time according to an exemplary embodiment may include a first server 31 and a second server 32, and further include a collecting device 33.

The collecting device 33 is a device which collects information about a supply state. The collecting device 310 may collect information about a supply state generated or input by a specific device as described above. Otherwise, the collecting device 310 may mean a specific device including a sensor and a processor, which are capable of collecting and processing information about supply quantities, of which a supply state is changed, and a time at which the supply state is changed, as described above.

The first server 31 may be a server which provides information about a supply state generated until products are warehoused or stored in real time and changing supply information including information about available-to-promise quantities. That is, the first sever 31 may be a server configured to perform functionality analogous to functionality of the supply information change component 110, which is described with reference to FIGS. 1 and 2.

The second server 32 may adjust a delivery deadline of delivery promised quantities by using the changed supply information in real time whenever the supply information is changed. That is, the second sever 32 may be a server configured to perform functionality analogous to functionality of the delivery deadline adjustment component 120 which is described with reference to FIGS. 1 and 2. The first server and the second server are hardware servers which may be positioned at locations physically spaced apart i.e., different physical locations/storage facilities, and connected with each other by wired communication or wireless communication to transceive information.

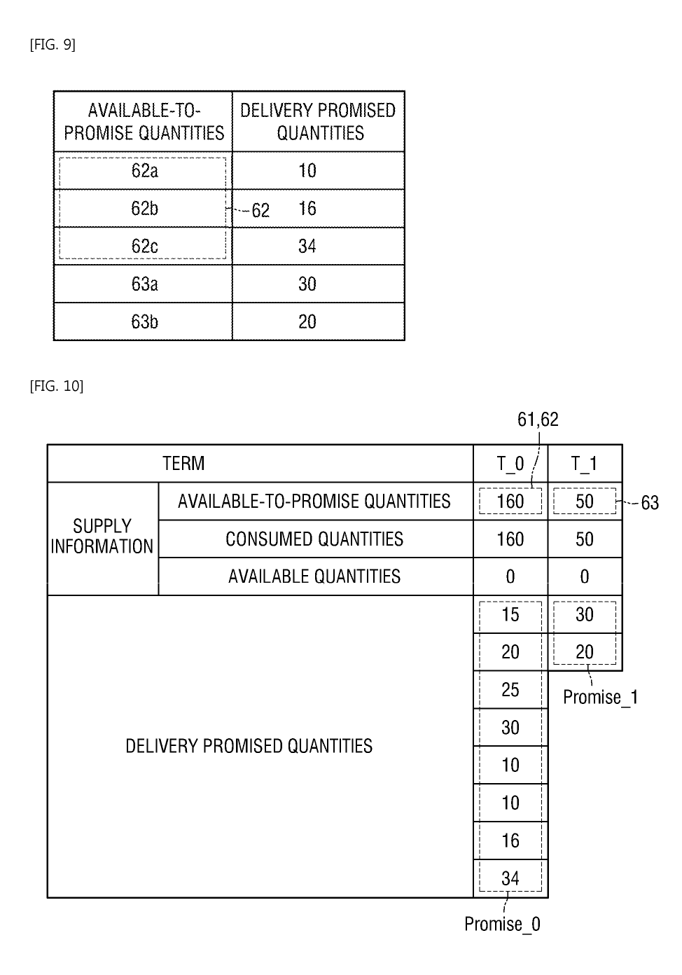

More detailed descriptions and other exemplary embodiments of the apparatus 100 and the system 300 which provide supply information in real time according to an exemplary embodiment will be understood based on a method of providing supply information in real time according to an exemplary embodiment described with reference to FIGS. 4 and 10.

A method of providing supply information in real time according to an exemplary embodiment may be performed by the apparatus 100 which provides supply information in real time according to an exemplary embodiment or the system 300 which provides supply information in real time according to an exemplary embodiment.

FIG. 4 is a flow chart illustrating a method of providing supply information in real time according to an exemplary embodiment.

A method of providing supply information in real time according to an exemplary embodiment will be described with reference to FIG. 4. When the supply information change component 110 may provide information on a supply state in real time and change supply information (in operation S410).

The delivery deadline adjustment component 120 may adjust a delivery deadline of delivery promised quantities by using the supply information changed in operation S410 (in operation S420).

Operation S420 of adjusting the delivery deadline of the delivery promised quantities by using the changed supply information may be performed in real time whenever the supply information is changed.

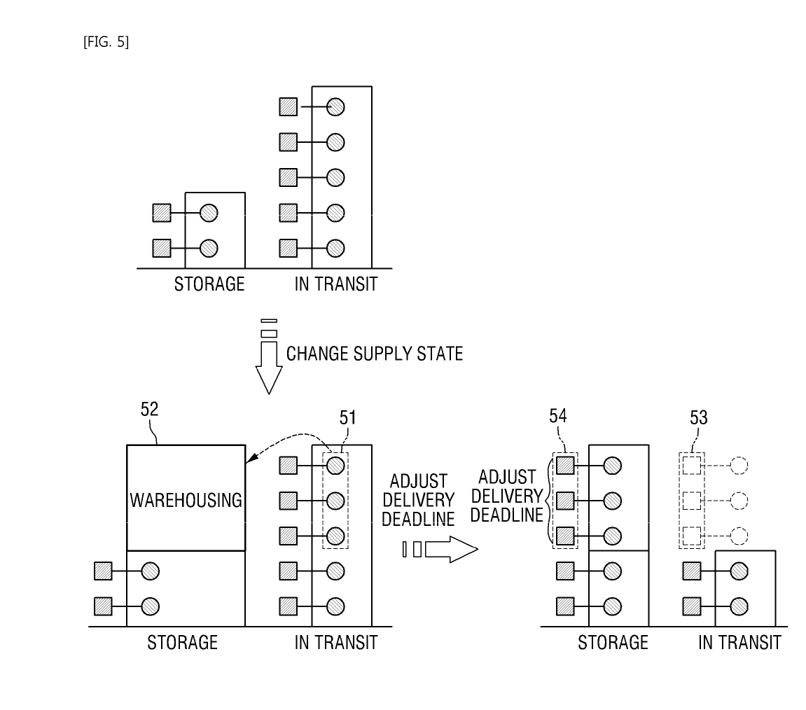

FIG. 5 is a flow diagram illustrating a relationship between supply information and delivery promised quantities according to an exemplary embodiment.

Referring to FIG. 5, the supply information includes information about available-to-promise quantities, and the information about available-to-promise quantities that are associated with the delivery promised quantities. For example, when the delivery promised quantities includes first delivery promised quantities that are supply quantities promised based on a first order, second delivery promised quantities that are supply quantities promised based on a second order, and third delivery promised quantities that are supply quantities promised based on a third order, the supply information may include information about first available-to-promise quantities associated with the first delivery promised quantities, information about second available-to-promise quantities associated with the second delivery promised quantities, and information about third available-to-promise quantities associated with the third delivery promised quantities.

The information about the available-to-promise quantities may include the available-to-promise quantities, information about delivery promised quantities associated with the available-to-promise quantities, and state information about the available-to-promise quantities. The information about the delivery promised quantities may include delivery promised quantities and delivery information. Current state information about the available-to-promise quantities may be linked with the supply state.

Accordingly, the information about the available-to-promise quantities associated with delivery allotment quantities may include available-to-promise quantities associated with the delivery allotment quantities, state information about available-to-promise quantities associated with the delivery allotment quantities, and the like.

Referring to FIG. 5, each of the squares is a separate delivery promised quantity. The delivery promised quantities may be separately divided according to an order generating delivery promised quantities. Further, even one order may generate two or more delivery promised quantities depending on contents of the order, and the order may be formally referred to as one order, but may be considered as two or more orders according to contents thereof.

That is, one square may be delivery promised quantities generated by one order according to an exemplary embodiment. In FIG. 5, a total of seven orders may exist (two orders in the state where products are warehoused or stored in a storage or a warehouse facility, and five orders that are in transit i.e., that are being transported). A circle shaded lines indicates available-to-promise quantities.

FIG. 5 illustrated an event (supply state change event) in which some of the available-to-promise quantities scheduled as in-transit at a present time are warehoused in a storage at an earlier than scheduled time.

Before a supply state change, in which products are warehoused in a storage or a warehouse at an earlier than a schedule time, available-to-promise quantities that are stored or warehoused in the storage or a warehouse, are two. It may be considered that each of the available-to-promise quantities is associated with specific delivery promised quantities.

Subsequently, referring to a case before the supply state change is generated in FIG. 5, available-to-promise quantities in-transit state are five. It may be considered that each of the five available-to-promise quantities in the in-transit state is associated with specific delivery promised quantities. This is provided by way of an example only and not by way of a limitation.

When three available-to-promise quantities from among five available-to-promise quantities are in the in-transit state are warehoused or stored 51 and 52 in a storage or a warehouse at an earlier than a scheduled time, so that the supply state is changed, the supply information about three available-to-promise quantities warehoused or stored in the storage or the warehouse at the earlier than the scheduled time, is changed. Particularly, information about the three available-to-promise quantities warehoused or stored in the storage or the warehouse at the earlier than the scheduled time is changed. For example, the method of providing supply information in real time according to an exemplary embodiment may change state information about the three available-to-promise quantities warehoused in the storage or a warehouse at the earlier than the scheduled time from the in-transit state to a warehouse/storage or delivery state.

Subsequently, referring to FIG. 5, a state in which a delivery deadline of delivery promised quantities 53 associated with the available-to-promise quantities related to each of the three products arriving at the earlier time from among the five in-transit products is adjusted 54.

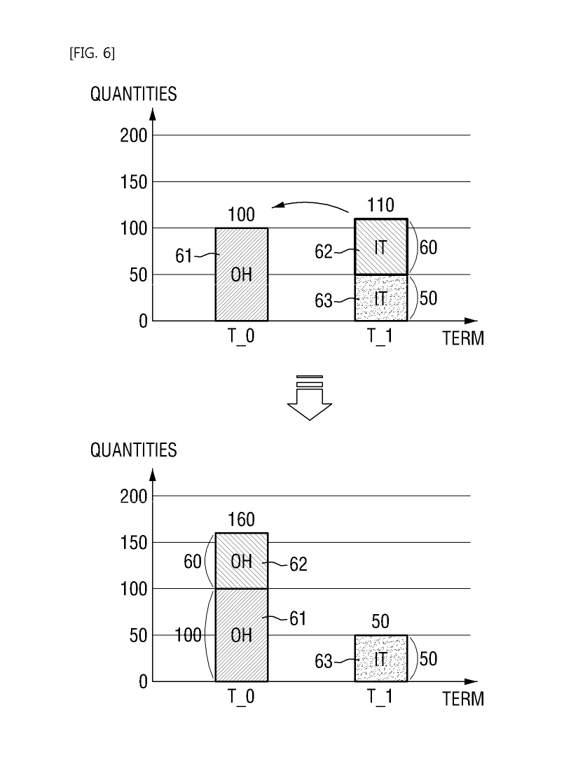

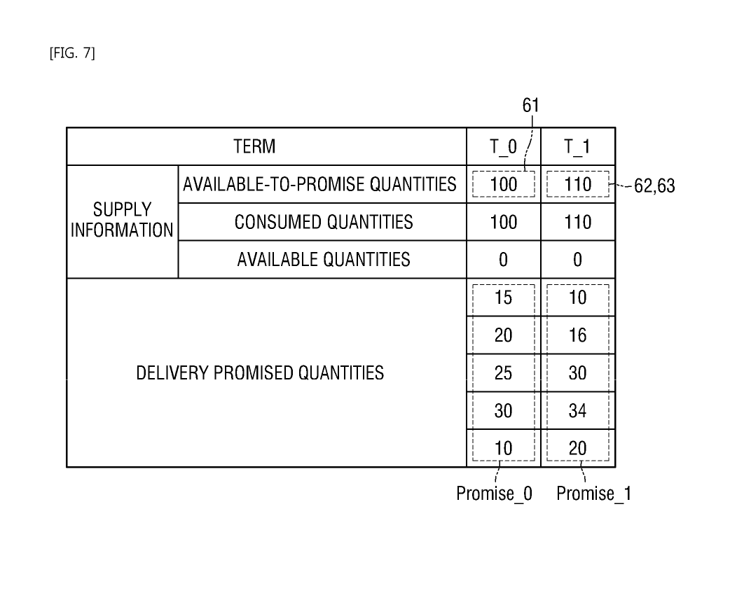

An exemplary embodiment in which supply information is provided in real time, so that a delivery deadline of delivery promised quantities is changed will be described with reference to FIGS. 6 to 10.

For understanding of an exemplary embodiment, in FIGS. 6 to 10, an instance where some of the available-to-promise quantities scheduled in the in-transit state at a current time arrive at an earlier than a schedule time will be described by way of an example in which supply information including information about available-to-promise quantities is changed by providing information about a supply state.

FIG. 6 is a flow diagram illustrating an instance where at least a portion of the products arrive at an earlier than a scheduled time according to an exemplary embodiment.

Referring to an exemplary embodiment depicted in FIG. 6, there are 110 promise-to-available quantities in the in-transit (IT) state at a term T_{—}1 including a scheduled time according to a schedule. Further, there are 100 promise-to-available quantities in an on-hand (OH) state in a storage or a warehouse at a term T_{—}0 including the earlier than the scheduled time (for example, a term including a current time or a term for which a change in a supply state is provided and supply information is changed).

Referring to FIG. 6, it is illustrated that 60 available-to-promise quantities selected from among the available-to-promise quantities which are currently in-transit and of which a transport is scheduled to be completed or delivery is planned at a term T_{—}1 (for example, the completion of the transport or delivery is when the products arrive at a storage place such as a warehouse, or are warehoused or stored in a storage place such as a warehouse) are completely transported or delivered for any reason (for example, a component of manufacturing the products arrives early, the products are manufactured early, or the products are transported at an earlier date and/or time) at the term T_{—}0 that is the earlier than the scheduled time.

That is, 60 of the available-to-promise quantities 62 selected from among the available-to-promise quantities are scheduled to be in-transit based on the current time according to the schedule and completely transported or delivered at the term T_{—}1, so that the products are scheduled to be warehoused, stored, or delivered, but the transportation is completed or they are delivered at the term T_{—}0 as opposed to the scheduled T_{—}1, and the products are warehoused or stored in the storage place such as the warehouse. Accordingly, a state of 60 of the available-to-promise quantities 62 selected from among the available-to-promise quantities is changed to the warehousing or storing state for the term T_{—}0 which includes the present time, so that a total of 160 of available-to-promise quantities is in the warehousing or storage state in the storage or a warehouse, and the like.

FIGS. 7 to 9 are charts illustrating a change of supply information and an adjustment of a delivery deadline of delivery promised quantities according to an exemplary embodiment.

In an exemplary embodiment, a change of supply information and an adjustment of a delivery deadline of delivery promised quantities in an instance analogous to an instance illustrated in FIG. 6 will be described with reference to FIGS. 6 to 9.

Referring to FIGS. 6 and 7, available-to-promise quantities ATP_{—}1 in the term T_{—}1 including a scheduled time are 110, 62 and 63, and available-to-promise quantities ATP_{—}0 in the term T_{—}0 including an earlier time are 100 61. FIG. 7 illustrates an instance before information about a supply state is generated because warehousing or storing of 60 in-transit available-to-promise quantities 62 is not yet completed, according to an exemplary embodiment.

Subsequently, referring to FIG. 7, delivery promised quantities Promise_{—}1 in the term T_{—}1 are a total of 110 which is a sum of 10, 16, 30, 34, and 20. Each of the delivery promised quantities included in the delivery promised quantities Promise_{—}1 may be associated with information about specific available-to-promise quantities. This will be described in more detail with reference to FIG. 9 according to an exemplary embodiment.

The delivery promised quantities Promise_{—}0 at the term T_{—}0 are a total of 100 which is a sum of 15, 20, 25, 30, and 10. Each of the delivery promised quantities included in the delivery promised quantities Promise_{—}0 at the term T_{—}0 may be associated with information about specific available-to-promise quantities according to an exemplary embodiment.

Referring to FIG. 7, consumed quantities may mean a sum of delivery promised quantities distributed for each segmentalized item. Accordingly, in an exemplary embodiment, the consumed quantities at the term T_{—}0 may be 100 similar to Promise_{—}0, and the consumed quantities in the term T_{—}1 may be 110 similar to Promise_{—}1.

An available supply may be a supply obtained by subtracting the consumed quantities (the sum of the segmentalized delivery promised quantities) from the available-to-promise quantities. Accordingly, the available supply at the term T_{—}0 is 0 which is obtained by subtracting 100 from 100, and the available supply at the term T_{—}1 is 0 which is obtained by subtracting 110 from 110.

Referring to FIGS. 6 and 8, 60 of available-to-promise quantities 62 selected from among the available-to-promise quantities, which are in transit and scheduled to be transported or delivered at the term T_{—}1, arrive at an earlier than the scheduled time, so that information about the supply state is generated, and supply information including the available-to-promise quantities may be changed by, for example, the supply information change component 110.

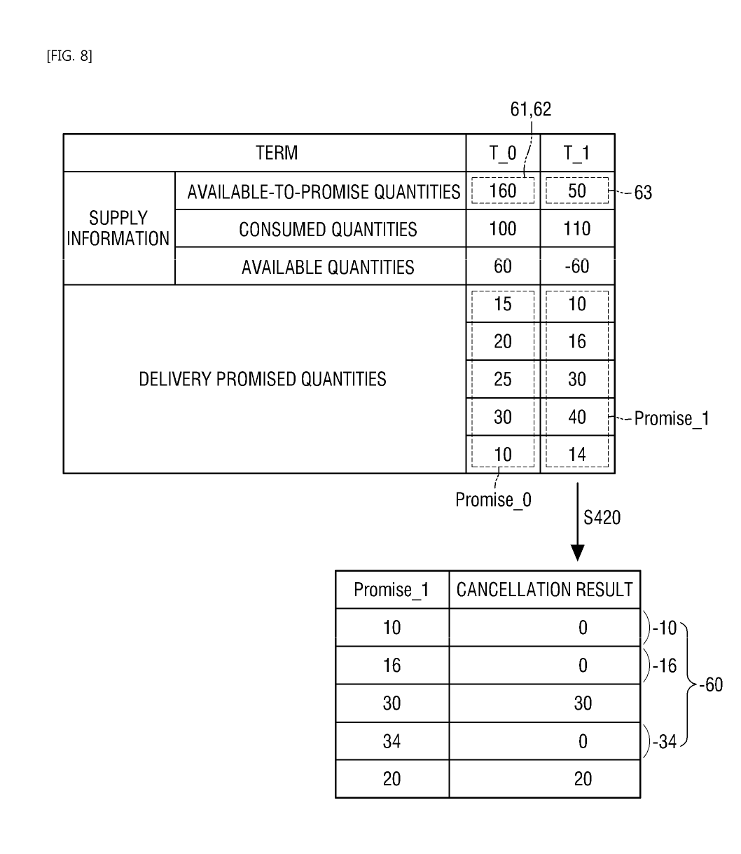

Referring to FIG. 8, according to an exemplary embodiment, the supply information change component 110 may change the information about the available-to-promise quantities, so that 60 of the available-to-promise quantities 62, which arrive at an earlier than the scheduled time, so that the supply state thereof is changed, are included in the available-to-promise quantities ATP_{—}0 at the term T_{—}0 including the earlier time by using the information about the supply state.

That is, the supply information change component 110 may change the state of the 60 of available-to-promise quantities 62 from the in-transit state to the warehousing or storage state by using the information about the supply state.

The delivery deadline adjustment component 120 may adjust a delivery deadline of the available supply or the available-to-promise quantities 62, of which the state information is changed by the supply information change component 110.

Particularly, referring to a table at a lower end of FIG. 8, according to an exemplary embodiment, there is delivery promised quantities associated with the 60 of the available-to-promise quantities 62, of which the state information is changed by the supply information change component 110.

FIG. 9 is a chart illustrating delivery promised quantities associated with the available-to-promise quantities, of which the state information is changed according to an exemplary embodiment.

Referring to FIG. 9, according to an exemplary embodiment, the delivery promised quantities Promise _{—}1 at the term T_{—}1 includes 10 that are first delivery promised quantities, 16 that are second delivery promised quantities, 34 that are third delivery promised quantities, 30 that are fourth delivery promised quantities, and 20 that are fifth delivery promised quantities.

The available-to-promise quantities 62, of which the state information is changed, include first available-to-promise quantities 62a, second available-to-promise quantities 62b, and third available-to-promise quantities 62c. Further, available-to-promise quantities 63, of which the information is not changed at the term T_{—}1, may include fourth available-to-promise quantities 63a and fifth available-to-promise quantities 63b.

Subsequently, referring to FIG. 9, 10 that are first delivery promised quantities may be associated with information about the first available-to-promise quantities 62a, 16 that are second delivery promised quantities may be associated with information about the second available-to-promise quantities 62b, and 34 that are third delivery promised quantities may be associated with information about the third available-to-promise quantities 62c.

30 fourth delivery promised quantities may be associated with information about the fourth available-to-promise quantities 63a, and 20 fifth delivery promised quantities may be associated with information about the fifth available-to-promise quantities 63b.

Referring back to FIG. 8, the delivery deadline adjustment component 120 may adjust the delivery deadline of each of 10 delivery promised quantities, 16 delivery promised quantities, and 34 delivery promised quantities based on the 60 available-to-promise quantities 62a, 62b, and 62c, of which the information is changed by the supply information change component 110.

That is, the delivery deadline adjustment component 120 may adjust a delivery deadline of the 60 delivery promised quantities (the sum of 10, 16, and 34) selected from among the delivery promised quantities at the term T_{—}1 to the term T_{—}0.

The delivery deadline adjustment component 120 may adjust the delivery deadline of the delivery promised quantities by using the changed supply information, and designate a delivery date, which is adjusted considering supply state change contents or available-to-promise quantity state change contents. Otherwise, when the supply state is changed, such as the available-to-promise quantities are warehoused or stored at an earlier than a scheduled time, the delivery deadline adjustment component 120 may designate a delivery date which is adjusted considering the earlier time.

FIG. 10 is a chart illustrating a delivery promised supply adjusted based on the supply information changed by the delivery deadline adjustment component according to an exemplary embodiment.

Referring to FIG. 10, the delivery of the 10 delivery promised quantities, 16 delivery promised quantities, and 34 delivery promised quantities associated with the 60 available-to-promise quantities 62a, 62b, and 62c (shown in FIG. 9), of which the information on the delivery promised quantities with the designated delivery date of the term T_{—}1 is adjusted to the term T_{—}1.

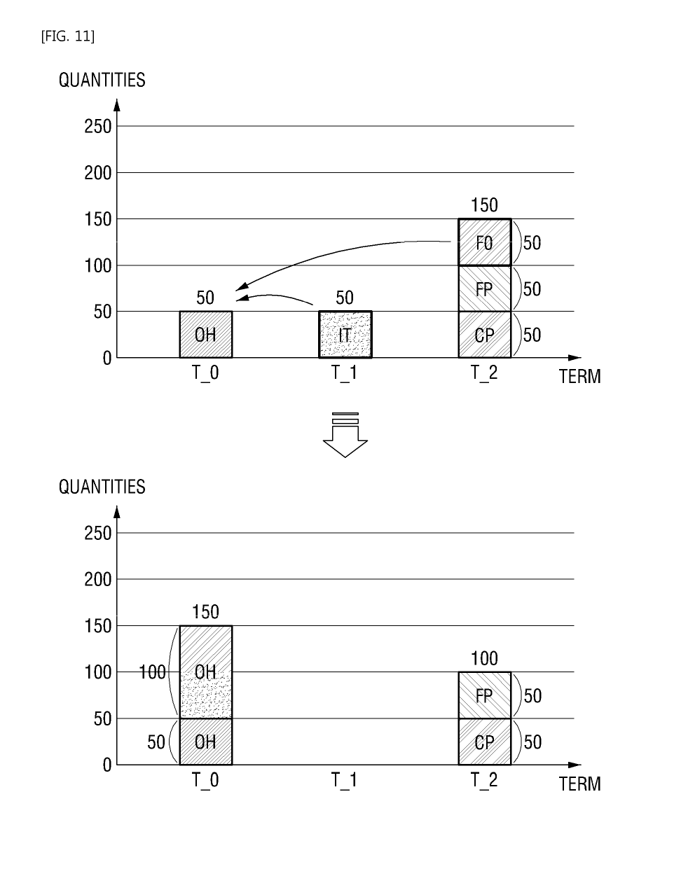

FIG. 11 is a flow diagram illustrating a change in supply information according to an exemplary embodiment.

In an exemplary embodiment with reference to FIGS. 6 to 10, an exemplary instance, where some of available-to-promise quantities scheduled in the in-transit state at a present time arrive at an earlier than a scheduled time, has been described. However, the information on the supply state generated until the products according to the supply information are warehoused or stored may also include information on all types of supply state generated from the production plan of the products until the products are warehoused or stored.

For example, referring to FIG. 11, there are 50 available-to-promise quantities in a “factory-on-hand (FO)” state in a term T_{—}2, 50 available-to-promise quantities in an “FP” state in the term T_{—}2, and 50 available-to-promise quantities in a “confirmed plan (CP)” state in the term T_{—}2, and there are 50 available-to-promise quantities in the in-transit (“IT”) state in the term T_{—}1. Further, it can be identified that there are 50 available-to-promise quantities in the OH state in the term T_{—}0.

The terms T_{—}0, T_{—}1, and T_{—}2 may be a unit term, such as a day and a week, and may also be a term, such as 6 hours, 2 days, and 12 hours. In yet another exemplary embodiment, the term may be a particular point in time e.g., midnight on Jan. 1, 2014. The description will be continuously given on an assumption that the term T_{—}0 is a second Monday in April, 2014, the term T_{—}1 is a second Tuesday in April, 2014, and the term T_{—}2 is a second Wednesday in April, 2014.

Subsequently, referring to an exemplary embodiment in FIG. 11, 50 available-to-promise quantities in the “OH” state in the term T_{—}0 means that there are 50 available-to-promise quantities in the “OH” state on a second Monday in April, 2014. 50 available-to-promise quantities in the “IT” state in the term T_{—}1 means that there are 50 available-to-promise quantities in the IT state on a second Tuesday in April, 2014, and are scheduled to arrive on a second Tuesday in April, 2014.

Particularly, 50 available-to-promise quantities in the “CP” state in the term T_{—}2 mean that there are 50 available-to-promise quantities in the CP state, in which a production plan is confirmed, on a second Wednesday in April, 2014, and are scheduled to arrive on a second Tuesday in April, 2014.

50 available-to-promise quantities in the “FP” state in the term T_{—}2 mean that there are 50 available-to-promise quantities in the CP state, in which a production plan is firmly and inflexibly confirmed, on a second Wednesday in April, 2014, and are scheduled to arrive on a second Tuesday in April, 2014.

50 available-to-promise quantities in the “FO” state in the term T_{—}2 mean that there are 50 available-to-promise quantities in the FO state in a storage or a warehouse of a factory on a second Wednesday in April, 2014, and are scheduled to arrive on a second Tuesday in April, 2014.

Subsequently, referring to the bottom chart in FIG. 11, it can be identified that 50 available-to-promise quantities (50 available-to-promise quantities in the “IT” state in upper chart in FIG. 11), which have a supply state of the IT state on a second Monday in April, 2014, and are scheduled to arrive on a second Tuesday in April, 2014 arrive on a second Monday in April, 2014 which is earlier than a scheduled time.

It can be identified that 50 available-to-promise quantities (50 available-to-promise quantities in the “FO” state in the top chart in FIG. 11), which has a supply state of the OH state in the storage or the warehouse of the factory on a second Monday in April, 2014, and is scheduled to arrive on a second Wednesday in April, 2014 arrives on a second Monday in April, 2014 which is an earlier than the scheduled time.

Accordingly, 50 available-to-promise quantities in the warehousing or storage state are scheduled to exist in the term T_{—}0 according to the schedule, but a total of 150 available-to-promise quantities becomes in the warehousing or storage state by the products arriving at an earlier than the scheduled time. In an exemplary embodiment illustrated in FIG. 11, information about the supply state representing that 50 available-to-promise quantities, which are scheduled to arrive in the term T_{—}1, are warehoused or stored in the term T_{—}0 that is the term including the earlier than the scheduled time, and 50 available-to-promise quantities, which are scheduled to arrive in the term T_{—}2, are warehoused or stored in the term T_{—}0 that is the term including the earlier than the scheduled time is generated.

Subsequently, in an exemplary embodiment illustrated in FIG. 11, the supply information change component 110 may change the supply information including the information about the available-to-promise quantities by applying the generated information to update the supply information. Particularly, the supply information change component 110 may change the available-to-promise quantities in the term T_{—}0 from 50 to 150, which is increased by 100.

The supply information change component 110 may change the available-to-promise quantities in the term T_{—}1 from 50 to 0. Further, the supply information change component 110 may change the available-to-promise quantities in the term T_{—}2 from 150 to 100 which are decreased by 50. The delivery deadline adjustment component 120 may adjust a delivery deadline of the delivery promised quantities according to the supply information changed by the supply information change component 110. For example, the delivery deadline adjustment component 120 may adjust a delivery deadline of the delivery promised quantities associated with the 50 available-to-promise quantities in the “FO” state in the term T_{—}2, in which the supply state of the 50 available-to-promise quantities is changed to the “OH” state in the term T_{—}0, from the term T_{—}2 to the term T_{—}0.

In FIG. 11, it an instance where the supply state of the available-to-promise quantities in the “FO” state in the term T_{—}2 is changed to the “OH” state in the term T_{—}0 according to an exemplary embodiment, is depicted, but there may be an example in which the supply state of the available-to-promise quantities in the “FO” state in the term T_{—}2 is changed to the “IT” state in the term T_{—}1. In this instance, according to an exemplary embodiment, the supply information change component 110 may change the supply information including the information about the available-to-promise quantities in the term T_{—}2 by using the information about the changed supply state, and the delivery deadline adjustment component 120 may adjust a delivery deadline of the delivery promised quantities associated with the changed information about the available-to-promise quantities by using the changed supply information. For example, the delivery deadline adjustment component 120 may adjust a delivery deadline of the delivery promised quantities associated with the 50 available-to-promise quantities in the “FO” state in the term T_{—}2, in which the supply state of the 50 available-to-promise quantities is changed to the “IT” state in the term T_{—}1, from the term T_{—}2 to the term T_{—}1.

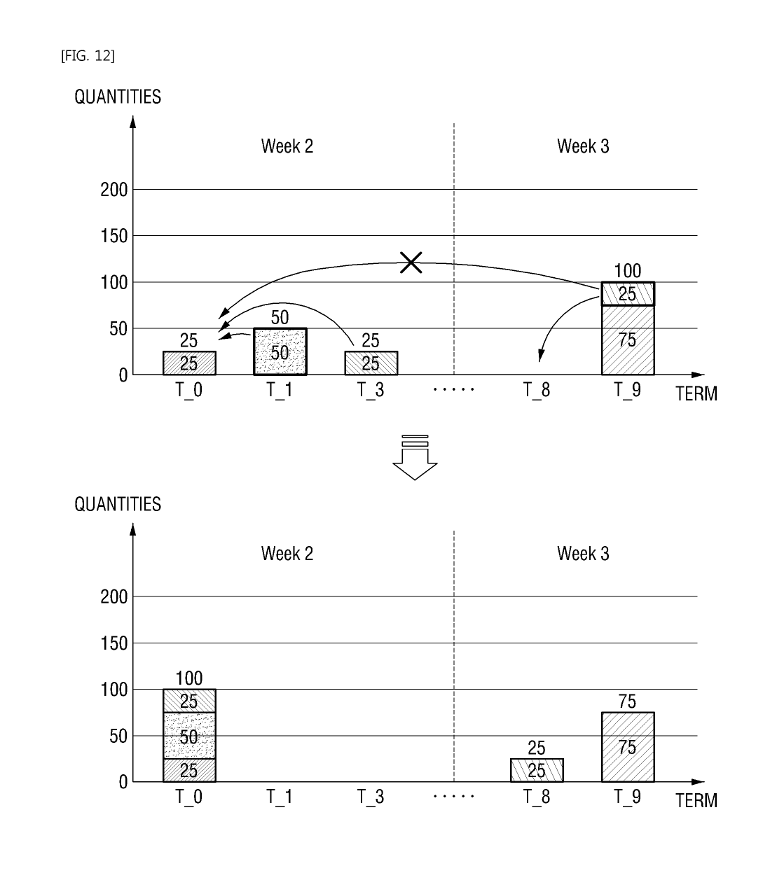

FIG. 12 is a flow diagram illustrating a delivery deadline of a delivery promised supply being adjusted according to an exemplary embodiment.

In FIG. 12, according to an exemplary embodiment, a term T_{—}0 is a second Monday in April 2014, a term T_{—}1 is a second Tuesday in April 2014, a term T_{—}3 is a second Wednesday in April 2014, a term T_{—}8 is a third Monday in April 2014, and a term T_{—}9 is a third Tuesday in April 2014. The second Monday in April 2014 may be a day including a current/present time according to an exemplary embodiment.

Referring to an upper chart of FIG. 12, 50 available-to-promise quantities which are scheduled to be warehoused or stored on a second Tuesday in April 4, 2014 (T_{—}1), 25 available-to-promise quantities which are scheduled to be warehoused or stored on a second Wednesday in April 4, 2014 (T_{—}3), and 25 available-to-promise quantities which are scheduled to be warehoused or stored on a third Tuesday in April 4, 2014 (T_{—}9) arrive on a third Monday in April 2014 (T_{—}8) that is earlier than a scheduled time, so that information about a supply state is generated.

Referring to a bottom chart of FIG. 12, information about the available-to-promise quantities in each term changed by the supply information change component 110. That is, the supply information change component 110 may change the states of 50 available-to-promise quantities, 25 available-to-promise quantities, and 25 available-to-promise quantities, which are warehoused or stored at an earlier than the scheduled time, to the warehoused or stored states, and change the supply information to a total of 100 available-to-promise quantities in the period T_{—}0. However, according to a predetermined policy, there may be a limit set that the supply information change component 110 may change the information about the available-to-promise quantities warehoused or stored at an earlier than a scheduled time only within a predetermined term.

For example, in FIG. 12, the predetermined term may be a week unit, and the term of the predetermined week unit may be from Monday to Sunday. In the example, the supply information change component 110 may not change the supply information of the available-to-promise quantities, which are scheduled to arrive in the term T_{—}9, but are warehoused in the term T_{—}0, to the available-to-promise quantities in the term T_{—}0, but change the supply information to the available-to-promise quantities in the T_{—}8 that is the earliest term within the predetermined time.

According to an exemplary embodiment, the flow cycle for products from a manufacturer to a consumer can be decreased based on updating supply and adjusting delivery information on the fly. For example, if products reach a warehouse or a storage facility earlier than anticipated, the supply inventory is updated on the fly. Based on the updated supply inventory, delivery dates may be adjusted and the products may leave the supply facility or a warehouse earlier than the scheduled plan. As a result, the products may reach the consumer earlier than the scheduled date and spend less time in the storage facility, saving time and money.

Exemplary embodiments described with reference to FIGS. 4 to 12 may be implemented by a computer readable code on a computer readable medium. The computer readable recording medium may include, for example, a mobile recording medium (a CD, a DVD, a Blu-Ray disc, a USB storage device, and a mobile hard disk), or a fixed recording medium (a ROM, a RAM, a computer-embedded hard disk). The computer program recorded in the computer readable recording medium may be transmitted to another computing device through a network, such as Internet, and installed in another computing device, and thus, be used in another computing device.

Each constituent element of FIG. 1 may mean software, or hardware, such as a field-programmable gate array (FPGA) or an application-specific integrated circuit (ASIC). However, the constituent elements are not limited to software or hardware, and may be configured to be included in an addressable storage medium, or to execute one or more processors. Functions provided within the constituent elements may be implemented by further segmentalized constituent elements, and by one constituent element for performing a specific function by combining a plurality of constituent elements.

The foregoing describes illustrative, non-limiting embodiments and is not to be construed as limiting. Although a few exemplary embodiments have been described, those skilled in the art will readily appreciate that many modifications are possible in exemplary embodiments without materially departing from an inventive concept. Accordingly, all such modifications are intended to be included within the scope of an inventive concept. Therefore, it is to be understood that the foregoing are illustrative, exemplary embodiments and an inventive concept is not to be construed as limited to exemplary embodiments disclosed, and that modifications to exemplary embodiments, as well as other embodiments, are intended to be included within the scope of an inventive concept. The inventive concept is defined by the following claims and their equivalents.

What is claimed is:

1. A method of providing supply information, comprising:
receiving, by a first apparatus, in response to a change in supply state of products, information about the supply state from a device configured to collect the information about the supply state generated before the products are stored;
providing, in real-time, by the first apparatus, the received information about the supply state and changing the supply information comprising information about available-to-promise quantities of the products, based on the received information about the supply state; and
in response to said changing of the supply information, adjusting, in real-time, by the first apparatus, a delivery deadline of delivery promised quantities of the products, based on the changed supply information.

2. The method of claim 1, wherein the delivery promised quantities comprise: a first delivery promised quantities which are promised supply quantities for a first order and second delivery promised quantities which are promised supply quantities for a second order, and
wherein said changing of the supply information comprises changing at least one of information about first available-to-promise quantities associated with the first delivery promised quantities, and information about second available-to-promise quantities associated with the second delivery promised quantities.

3. The method of claim 2, wherein said adjusting of the delivery deadline comprises adjusting only a delivery deadline of the first delivery promised quantities without adjusting a delivery deadline of the second delivery promised quantities in response to a supply state of at least a portion of the products being changed such that information about the first available-to-promise quantities is changed and information about the second available-to-promise quantities remain the same.

4. The method of claim 3, wherein, in response to the change of the supply state of at least said portion of the products, which is generated based on the first available-to-promise quantities being stored at an earlier time than a scheduled time, the adjusting of the delivery deadline further comprises adjusting a delivery deadline of the first delivery promised quantities based on the earlier time during which the first available-to-promise quantities are stored.

5. The method of claim 1, wherein the information about the supply state further comprises at least one information selected from among: information about a production plan state, information about a factory inventory state, information about an in-transit state, and information about a storage state.

6. A non-transitory computer readable medium storing a computer program comprising instructions that when executed by a computer cause the computer to:
receive, in response to a change in a supply state of products, information about the supply state from a device configured to collect the information about the supply state generated before the products are stored;
providing, in real-time, the received information about the supply state;
changing the supply information comprising information about available-to-promise quantities of the products; and
in response to said changing of the supply information, adjusting, in real-time, a delivery deadline of delivery promised quantities of the products based on the changed supply information.

7. An apparatus configured to provide supply information, the apparatus comprising:
a memory configured to store a computer program code for executing a method of providing supply information; and
a processor configured to execute the stored computer program code,
wherein the processor comprises:
a supply information change component configured to receive, in response to a change in a supply state of products, information about the supply state of the products from a device configured to collect the information about the supply state generated before the products are stored, to provide, in real-time, the received information about the supply state, and to change the supply information comprising information about available-to-promise quantities of the products, and
in response to said changing of the supply information, a delivery deadline adjustment component is configured to adjust a delivery deadline of delivery promised quantities of the products based on the changed supply information.

8. The apparatus of claim 7, wherein the delivery promised quantities comprise a first delivery promised quantities which are promised supply quantities for a first order, and a second delivery promised quantities which are promised supply quantities for a second order, and
wherein the supply information change component further changes at least one of: information about first available-to-promise quantities associated with the first delivery promised quantities, and information about second available-to-promise quantities associated with the second delivery promised quantities.

9. The apparatus of claim 8, wherein the delivery deadline adjustment component adjusts only a delivery deadline of the first delivery promised quantities without adjusting a delivery deadline of the second delivery promised quantities in response to a supply state of at least a portion of the products being changed such that information about the first available-to-promise quantities is changed, and information about the second available-to-promise quantities remain the same.

10. A system of providing supply information, comprising:
a first server configured to receive, in response to a change in a supply state of products, information about the supply state of the products from a device configured to collect the information about the supply state generated before the products are stored, to provide, in real-time, the received information about the supply state, and to change supply information comprising information about available-to-promise quantities of the products based on the received information about the supply state, and
a second server configured to receive the changed supply information from the first server, and to adjust, in real-time, a delivery deadline of delivery promised quantities based the received changed supply information.

11. The system of claim 10, further comprising:
a supply state information collecting device configured to collect information about the supply state, and configured transmit the collected information to the first server,
wherein the supply state information collecting device comprises a sensor configured to collect and process information about supply quantities, of which a supply state is changed, and a time, at which the supply quantities are changed.

12. The method of claim 1, wherein the changing the supply information comprises changing the supply information based on the received information about the supply state and based on a predetermined threshold.

13. The method of claim 1, wherein the changing the supply information comprises limiting change in the supply information based on a predetermined threshold in response to the received information about the supply state exceeding the predetermined threshold.
